(19) United States
(12) Patent Application Publication
(10) Pub. No.: US 2015/0327153 A1
(43) Pub. Date: Nov. 12, 2015

(54) NON-CONFLICTING TRAFFIC CONTROL WITH DIFFERENT TYPES OF NETWORK SELECTION INFORMATION

(71) Applicants: Janne Petteri TERVONEN, ESPOO (FI); Janne MARIN, Espoo (FI); Sverre SLOTTE, Espoo (FI)

(72) Inventors: Janne Petteri TERVONEN, ESPOO (FI); Janne MARIN, Espoo (FI); Sverre SLOTTE, Espoo (FI)

(73) Assignee: NOKIA SOLUTIONS AND NETWORKS OY, Espoo (FI)

(21) Appl. No.: 14/379,836

(22) PCT Filed: Feb. 28, 2012
(86) PCT No.: PCT/EP2012/053316

§ 371 Date: Aug. 20, 2014

(51) Int. Cl. H04W 48/08; H04W 48/18

(52) U.S. Cl. CPC H04W 48/08; H04W 48/18

(57) ABSTRACT

There are provided measures for non-conflicting traffic control with different types of network selection information. Such measures exemplarily comprise performing traffic control based on a combination of (e.g. cellular type) access-related network selection information with respect to a network or a network technology type with (e.g. non-/cellular type) routing-related network selection information with respect to traffic type based routing information. Such measures are exemplarily, but not exclusively, applicable in the context of coexisting cellular and non-cellular networks or network technology types providing connectivity to a transport network.

### FIELD

The present invention relates to non-conflicting traffic control with different types of network selection information. More specifically, the present invention exemplarily relates to measures (including methods, apparatuses and computer program products) for realizing non-conflicting traffic control with different types of network selection information.

### BACKGROUND

The present specification basically relates to traffic control (including network selection) in a communication system and/or network deployment in which various types of networks or network technology types are connected to a transport network. Such communication system and/or network deployment result from the trend towards interoperability between networks of different network technology types providing connectivity for terminals with a transport network providing specific services.

For example, the provision of IP connectivity to a cellular core network or the Internet via both cellular networks such as 3GPP networks and non-cellular networks such as WiFi (or WLAN) networks is currently attaining interest. Specifically, due to bandwidth and resource limitations in the cellular radio domain, operators of cellular systems are interested in offloading traffic (which is expected to drastically increase in the future) from the cellular networks to WiFi access. The general idea of WiFi offloading is to move some traffic away from the (typically rather congested) cellular networks, effectively increasing the network capacity of an operator when both cellular and WiFi networks can be utilized. In terms of WiFi offloading, it is basically conceivable that traffic is offloaded to WiFi only on the radio interface or in the radio access domain while the traffic is still routed via the operator's cellular core network as the transport network, or that traffic is offloaded directly to the Internet as the transport network, i.e. both the cellular radio interface or radio access domain and the cellular core network are offloaded.

In such communication system and/or network deployment in which various types of networks or network technology types are connected to a transport network, each of the different types of networks or network technology types typically employs its own type of network selection information or mechanism.

In particular, different operational paradigms in terms of traffic control and network selection meet in the context of WiFi offloading.

In cellular networks, the network is (almost) fully in charge of all traffic control, mobility and network selection decisions for the terminals served by the network. In terms of network selection, an access-related mechanism with respect to a network or a network technology type to be accessed is employed in cellular networks. However, in non-cellular networks such as WiFi networks, the situation is quite the opposite, as the terminals (or the users in the end) make the mobility and network selection decisions, i.e. what network to join and when. In terms of network selection, a routing-related mechanism with respect to traffic type based routing is employed in non-cellular networks such as WiFi networks (but is generally applicable in any network providing for IP connectivity, thus including also corresponding cellular networks). Accordingly, for the purpose of the present description, an access-related mechanism may also be referred to as a 3GPP mechanism, and a routing-related mechanism may also be referred to as an IETF mechanism.

In terms of network selection in the context of WiFi offloading, access-related network selection information may be provided to terminals from a cellular network (in the context of an access-related mechanism). For example, an Access Network Discovery and Selection Function (ANDSF) specified by 3GPP basically relates to a network or a network technology type, thus giving the operators a tool to influence also how their subscribers use WiFi and for what applications. Yet, in terms of network selection in the context of WiFi offloading, routing-related network selection information may be provided to terminals from cellular as well as non-cellular networks (in the context of a routing-related mechanism). For example, mechanisms for guiding terminals' routing decisions, which are specified by IETF, basically relate to traffic type based routing information (provided e.g. with Router Advertisement (RA) or DHCPv4/v6) to indicate to terminals what traffic should be routed towards what first hop router. When the possible first hop routers are behind different (access) networks or radio interfaces—e.g. WiFi and 3GPP access—it is effectively possible with such IETF mechanisms to indicate what traffic is to be guided via WiFi and what is not.

As terminals can be connected to several different (types of) networks or network technology types at the same time, the terminals may thus obtain different types of network selection information from different sources or by different mechanisms, e.g. from ANDSF specified in 3GPP, RA specified in IEFT, DHCP specified in IETF, or the like. Such different (types of) networks or network technology types may however be conflicting in terms of the network to be selected or the route to be decided based thereon.

However, in such communication system and/or network deployment in which various types of networks or network technology types are connected to a transport network, e.g. in the context of WiFi offloading, there is currently no means or mechanism to resolve such conflicts between different types of network selection information in terms of traffic control.

Therefore, there is a need to provide for non-conflicting traffic control with different types of network selection information

### SUMMARY

Various exemplary embodiments of the present invention aim at addressing at least part of the above issues and/or problems and drawbacks.

Various aspects of exemplary embodiments of the present invention are set out in the appended claims.

According to an exemplary aspect of the present invention, there is provided a method comprising obtaining access-related network selection information with respect to a network or a network technology type, obtaining routing-related network selection information with respect to traffic type based routing information, and performing traffic control based on a combination of the access-related network selection information and the routing-related network selection information.

According to an exemplary aspect of the present invention, there is provided an apparatus comprising an interface configured to communicate with at least another apparatus, a memory configured to store computer program code, and a processor configured to cause the apparatus to perform: obtaining access-related network selection information with respect to a network or a network technology type, obtaining routing-related network selection information with respect to traffic type based routing information, and performing traffic control based on a combination of the access-related network selection information and the routing-related network selection information.

According to an exemplary aspect of the present invention, there is provided a computer program product comprising computer-executable computer program code which, when the program is run on a computer (e.g. a computer of an apparatus according to the aforementioned apparatus-related exemplary aspect of the present invention), is configured to cause the computer to carry out the method according to the aforementioned method-related exemplary aspect of the present invention.

Such computer program product may comprise or be embodied as a (tangible) computer-readable (storage) medium or the like on which the computer-executable computer program code is stored, and/or the program may be directly loadable into an internal memory of the computer or a processor thereof.

Advantageous further developments or modifications of the aforementioned exemplary aspects of the present invention are set out in the following.

Any one of the above aspects enables a conflict resolution between different types of network selection information in terms of dynamic traffic control, particularly in the context of coexisting cellular and non-cellular networks or network technology types providing connectivity to a transport network. Accordingly, conflicts between different types of network selection information in terms of dynamic traffic control are enabled to be resolved in an efficient and reliable manner.

By way of exemplary embodiments of the present invention, there is provided non-conflicting traffic control with different types of network selection information. More specifically, by way of exemplary embodiments of the present invention, there are provided measures and mechanisms for non-conflicting traffic control with different types of network selection information.

Thus, improvement is achieved by methods, apparatuses and computer program products enabling/realizing non-conflicting traffic control with different types of network selection information.

### BRIEF DESCRIPTION OF THE DRAWINGS

In the following, the present invention will be described in greater detail by way of non-limiting examples with reference to the accompanying drawings, in which

FIG. 1 shows a schematic diagram of an exemplary system architecture for which exemplary embodiments of the present invention are applicable,

FIG. 2 shows a flowchart of a first example of a procedure according to exemplary embodiments of the present invention,

FIG. 3 shows a flowchart of a second example of a procedure according to exemplary embodiments of the present invention,

FIG. 4 shows a schematic diagram of a first exemplary use case according to exemplary embodiments of the present invention in the exemplary system architecture of FIG. 1,

FIG. 5 shows a schematic diagram of a first exemplary use case according to exemplary embodiments of the present invention in the exemplary system architecture of FIG. 1, and

FIG. 6 shows a schematic diagram of an exemplary apparatus in a system scenario according to exemplary embodiments of the present invention.

### DETAILED DESCRIPTION OF DRAWINGS AND EMBODIMENTS OF THE PRESENT INVENTION

The present invention is described herein with reference to particular non-limiting examples and to what are presently considered to be conceivable embodiments of the present invention. A person skilled in the art will appreciate that the invention is by no means limited to these examples, and may be more broadly applied.

It is to be noted that the following description of the present invention and its embodiments mainly refers to specifications being used as non-limiting examples for certain exemplary network configurations and deployments. Namely, the present invention and its embodiments are mainly described in relation to 3GPP specifications being used as non-limiting examples for certain exemplary network configurations and deployments. In particular, a 3GPP communication system is used as a non-limiting example for the applicability of thus described exemplary embodiments. As such, the description of exemplary embodiments given herein specifically refers to terminology which is directly related thereto. Such terminology is only used in the context of the presented non-limiting examples, and does naturally not limit the invention in any way. Rather, any other network configuration or system deployment, etc. may also be utilized as long as compliant with the features described herein.

In particular, the present invention and its embodiments may be applicable in any communication system and/or network deployment in which various types of networks or network technology types are connected to a transport network, wherein each of the different types of networks or network technology types employs its own type of network selection information or mechanism.

Hereinafter, various embodiments and implementations of the present invention and its aspects or embodiments are described using several variants and/or alternatives. It is generally noted that, according to certain needs and constraints, all of the described variants and/or alternatives may be provided alone or in any conceivable combination (also including combinations of individual features of the various variants and/or alternatives).

According to exemplary embodiments of the present invention, in general terms, there are provided measures and mechanisms for (enabling/realizing) non-conflicting traffic control with different types of network selection information.

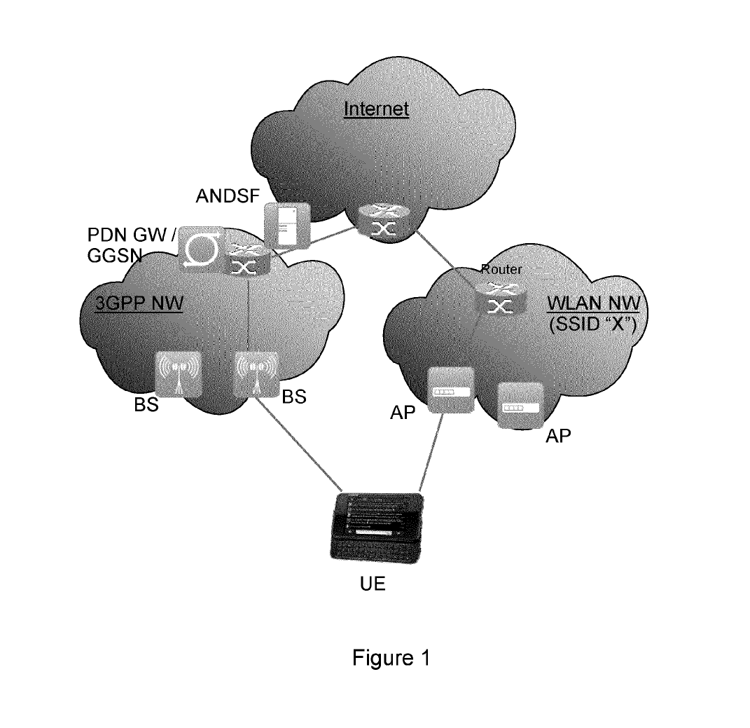

FIG. 1 shows a schematic diagram of an exemplary system architecture for which exemplary embodiments of the present invention are applicable.

As shown in FIG. 1, a system architecture is exemplarily assumed, in which a terminal is connected to the Internet representing a non-limiting example for a transport network providing specific services via both a 3GPP network and a WiFi network. In the 3GPP network representing a non-limiting example of a cellular network providing connectivity for the terminal, connectivity to the Internet is provided by an access network element such as a base station BS (such as e.g. NB or eNB) via core network element such as a PDN GW and/or a GGSN and/or a router. In conjunction with the 3GPP network, there is also provided an ANDSF server (which may be accessible via the 3GPP network or via the WiFi network and the Internet). In the WiFi network representing a non-limiting example of a non-cellular network providing connectivity for the terminal, connectivity to the Internet is provided by an access point AP and a router. The WiFi network is exemplarily assumed to be a WLAN network with identifier SSID “X”. It is noted that WiFi as used herein may encompass any WLAN (IEEE 802.11) and/or WiMAX (IEEE 802.16) access technologies.

The system architecture of FIG. 1 exemplarily relates to a case of WiFi offloading, in which traffic may be offloaded directly to the Internet via the WiFi network, i.e. both the cellular radio interface or radio access domain and the cellular core network are offloaded. Irrespective of such exemplary system architecture used for the subsequent description, exemplary embodiments of the present invention are equally applicable to a case of WiFi offloading, in which traffic is offloaded to the WiFi network only on the radio interface or in the radio access domain while the traffic is still routed via the operator's cellular core network.

In this case, there are different ways of connecting WiFi networks to a cellular core network. As one example, in an approach referred to as S2a interface in 3GPP terminology, the Internet in FIG. 1 could be replaced by the core network part of the 3GPP network (e.g. including the PDN GW and/or the GGSN). As another example, in an approach referred to as I-WLAN in case of a 3G core network and as S2b interface in case of an EPC core network in 3GPP terminology, a VPN tunnel could be established from the UE to the core network element, wherein the tunnel itself can traverse via the Internet before getting to the cellular core network. As still another example, in an approach referred to as S2c interface in 3GPP terminology, a host-based Mobile IP solution for non-3GPP access connectivity to the cellular core network can be adopted. Referring to the exemplary approaches mentioned above, it is noted that the S2c interface approach requires in practice a Mobile IP stack on the terminal, while in the S2a and S2b interface approaches the mobility is handled in the core network either with GTP or PMIP. Basically, the S2c interface approach can be operable on top of the S2a interface approach and/or the S2b interface approach.

Irrespective of the implemented way of connecting WiFi networks to a cellular core network, the main scenarios is in this regard could be summarized as follows.
1. Wi-Fi access is directly connected to cellular core, UE does not need to implement either VPN or (DS)MIP tunnel between the UE and cellular core, i.e. unmodified, existing UEs can be used (this scenario may correspond to the S2a interface approach in practice), or
2. Either VPN tunnel and/or (DS)MIP tunnel is required from the UE to the cellular core, i.e. there is required either VPN and/or (DS)MIP implementation on the UE (in practice, this scenario may correspond to the S2b interface approach with 3GPP EPC core, or the S2c over S2a interface approach or the S2c over S2b interface approach in practice).

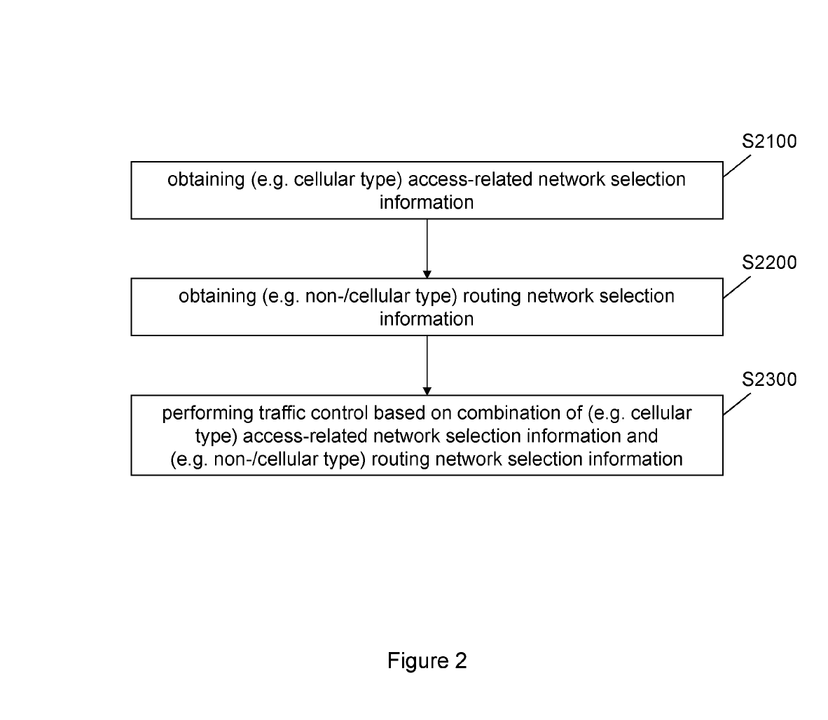

FIG. 2 shows a flowchart of a first example of a procedure according to exemplary embodiments of the present invention.

The exemplary procedure according to FIG. 2 is assumed to take place at a terminal or user equipment or modem connected with at least one network or network technology type, e.g. the UE shown in FIG. 1.

As shown in FIG. 2, a procedure according to exemplary embodiments of the present invention comprises an operation (S2100) of obtaining access-related network selection information with respect to a network or a network technology type, an operation (S2200) of obtaining routing-related network selection information with respect to traffic type based routing information, and an operation (S2300) of performing traffic control based on a combination of the access-related network selection information and the routing-related network selection information.

Generally, a network selection according to exemplary embodiments of the present invention relates to any kind of selection of any kind of network or part of an overall network or network deployment or communication system. Particularly but not exclusively, such network selection according to exemplary embodiments of the present invention may specifically relate to an access network selection, especially selection in terms of a radio access network or technology.

In view of the exemplary illustration of FIG. 1, it is noted that the obtaining operations may also be performed in the opposite sequence or (quasi) simultaneously.

According to exemplary embodiments of the present invention, the access-related network selection information may be of cellular type, i.e. this information may be provided from a cellular network element (from a cellular type interface), or of non-cellular type, i.e. this information may be provided from a non-cellular network element (from a non-cellular type interface), e.g. when an ANDSF server is accessed via public Internet or the like. Similarly, the routing-related network selection information may be of cellular type as well as of non-cellular type, i.e. this information may be provided from a cellular and/or non-cellular network element (i.e. an IP type interface). Namely, referring to the exemplary system architecture of FIG. 1, the access-related network selection information may relate to a cellular network such as a 3GPP network and may thus be based on a cellular such as a 3GPP network selection mechanism, while the routing-related network selection information may relate to a non-cellular network such as a WiFi network and/or a cellular network such as a 3GPP network and may thus be based on an IETF network selection mechanism.

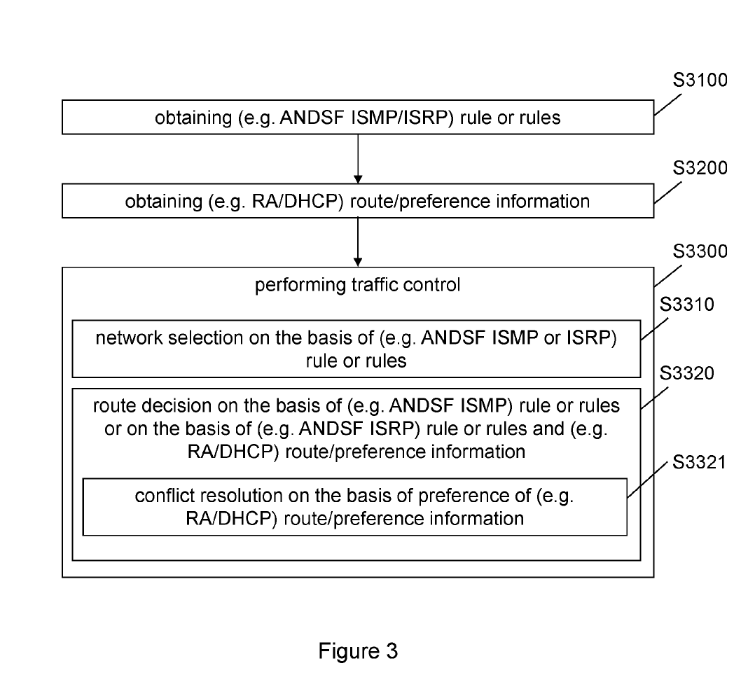

According to exemplary embodiments of the present invention, the access-related network selection information may be based on at least one of an inter-system mobility policy (ISMP) and an inter-system routing policy (ISRP) of an access network discovery and selection function (ANDSF), which may be provided by an ANDSF server, and the routing-related network selection information may be based on at least one of a router advertisement (RA) and a dynamic host configuration (e.g. a DHCPv4/v6 message, or options thereof), which may be provided by a router and a DHCP server (both of which may be implemented e.g. at/in/by a PDN GW and/or a GGSN in a cellular network), respectively. The exemplary procedure according to FIG. 3 below relates to such examples of network selection information.

FIG. 3 shows a flowchart of a second example of a procedure according to exemplary embodiments of the present invention.

Basically, the operations S3100, S3200 and S3300 of FIG. 3 may be regarded as exemplary realizations of the operations S2100, S2200 and S2300 of FIG. 2, respectively.

As shown in FIG. 3, a procedure according to exemplary embodiments of the present invention comprises an operation (S3100) of obtaining at least one of ISMP rule/s and ISRP rule/s (e.g. provided by ANDSF) as the access-related network selection information with respect to a network or a network technology type, an operation (S3200) of obtaining route information and preference information (e.g. provided by RA, DHCPv4/v6, etc.) as the routing-related network selection information with respect to traffic type based routing information, and an operation (S3300) of performing traffic control based on a combination thereof.

According to exemplary embodiments of the present invention, the access-related network selection information may thus comprise ANDSF network selection information called Inter-System Mobility Policy (ISMP), wherein ISMP is essentially a prioritized list of access networks, where WiFi networks are identified with SSID or a generic “WiFi” umbrella access type (i.e., if no SSID is defined but only access type is set to WLAN, it means any WLAN/WiFi network can be accessed when following that policy) is defined, and where for 3GPP accesses only a generic “3GPP” umbrella access type is defined. Further, the access-related network selection information may thus comprise ANDSF network selection information called Inter-System Routing Policy (ISRP), wherein it is indicated and there are three different main parts/nodes. Namely, ForFlowBased node is used with 3GPP IFOM feature, ForServiceBased node is used with 3GPP MAPCON feature, and ForNonSeamlessOffload node is used with 3GPP Non-Seamless WLAN Offload feature. In practice, the Non-Seamless WLAN Offload feature means that the UE is able to receive ANDSF ForNonSeamlessOffload node ISRP policy and then follows it for WiFi access.

Generally, all of the aforementioned features, parts or nodes of ANDSF network selection information are capable of providing for the same kind of (network selection) information as IETF mechanisms (e.g. based on RA).

Using access-related network selection information based on the ISMP is specifically applicable for terminals which are not capable of routing traffic simultaneously over multiple radio access interfaces (e.g. a non-IFOM or non-MAPCON capable UE, or a UE that has such a capability disabled, or a UE not capable of non-seamless WLAN offload), and using access-related network selection information based on the ISRP is specifically applicable for terminals which are capable of routing traffic simultaneously over multiple radio access interfaces (e.g. an IFOM or MAPCON capable UE, or a UE that has such a capability enabled, or a UE capable of non-seamless WLAN offload). The former terminals, i.e. terminals which are not capable of routing traffic simultaneously over multiple radio access interfaces, shall select the most preferable available access or network for inter-system mobility based on ISMP and user preferences and shall disregard any ISRP it may have obtained from the ANDSF.

According to exemplary embodiments of the present invention, as shown in FIG. 3, the traffic control operation (S3300) may comprise an operation (S3310) of selecting a network or a network technology type, and an operation (S3320) of deciding a route for routing of traffic of a specified traffic type. Further, the route decision operation (S3320) may comprise an operation (S3321) of resolving a conflict in the route decision.

In case the access-related network selection information is based on the ISMP, i.e. ANDSF ISMP is used at the terminal, the network or network technology type is selected on the basis of the ANDSF ISMP rule/s, and the route for routing of traffic of a specified traffic type is decided on the basis of the route information and preference information (of/as the routing-related network selection information). Accordingly, information based on a 3GPP mechanism, i.e. network selection policy information or rule/s from ANDSF, may be used for network/access selection, e.g. when and if a certain WiFi network is used. After this, information based on an IETF mechanism may be used for delivering more specific information what (application) traffic is to be offloaded. The terminal may thus follow the routing information received by an IETF mechanism to ensure that the (application) traffic is delivered in the most efficient way.

In case the access-related network selection information is based on the ISRP, i.e. ANDSF ISRP is used at the terminal, the network or network technology type is selected on the basis of the ANDSF ISRP rule/s, and the route for routing of traffic of a specified traffic type is decided on the basis of the ANDSF ISRP rule/s and the route information and preference information (of/as the routing-related network selection information). Accordingly, information based on a 3GPP mechanism, i.e. network selection policy information from ANDSF, may be used for network/access selection, e.g. when and if a certain WiFi network is used. After this, information based on a 3GPP mechanism and/or an IETF mechanism may be used for delivering more specific information what (application) traffic is to be offloaded. Namely, both ISRP rule/s and IETF mechanism/s may be used to select where certain (application) traffic is routed.

In case there is a conflict between ISRP rule/s and IETF mechanism/s in terms of route decision, the information based on the IETF mechanism's takes precedence. Namely, when there is a conflict between a route decision for routing of traffic of a specified traffic type on the basis of ISRP rule/rules and a route decision for routing of traffic of the specified traffic type on the basis of the route information and preference information (of/as the routing-related network selection information), the route for routing of traffic of the specified traffic type is decided by admitting precedence to the routing-related network selection information.

As evident from the above, according to exemplary embodiments of the present invention, a terminal obtains and employs network selection information from different types of mechanisms or sources, such as network selection information from an ANDSF and network selection information through IETF mechanisms (e.g. RA, DHCPv6/DHCPv4, etc.). In terms of traffic control, the terminal combines the network selection information from different types of mechanisms or sources, i.e. uses both types of network selection information in a combined manner. In this regard, the terminal may beneficially combine ANDSF network selection policies (ISMP or ISRP) together with (more) dynamic features of IETF mechanisms, thereby achieving effective access selection and/or traffic steering/assistance/guidance functionalities and enabling dynamic control of traffic flows even in changing network environments (e.g. with load and/or interference variations). That is, the (more) dynamic nature of (information based on) IETF mechanisms may be beneficially utilized in combination with the (information based on) 3GPP mechanisms exhibiting enhanced controllability from an operator's point of view. Further, potential conflicting access selection and/or traffic steering/assistance/guidance information from different sources may be resolved in an efficient and reliable (i.e. predictable) manner.

Accordingly, it is enabled that an operator effectively implements a communication system and/or network deployment in which various types of networks or network technology types are connected to a transport network, wherein each of the different types of networks or network technology types typically employs its own type of network selection information or mechanism. Also, it is enabled that an operator realized a specific network selection information or mechanism out of different types of network selection information or mechanism which are used by various types of networks or network technology types being connected to a transport network in a communication system and/or network deployment.

In both cases, terminals operating in accordance with exemplary embodiments of the present invention are capable of dealing with the different types of network selection information or mechanisms in an efficient and reliable manner. Therefore, a (cellular network) operator knows how terminals (connected to its cellular network) behave in such cases (including WiFi offloading cases). Thus, the (cellular network) operator has controllability in terms of traffic control and network selection even in such cases (including WiFi offloading cases), thereby raising attractiveness for deployment of such cases (including WiFi offloading cases).

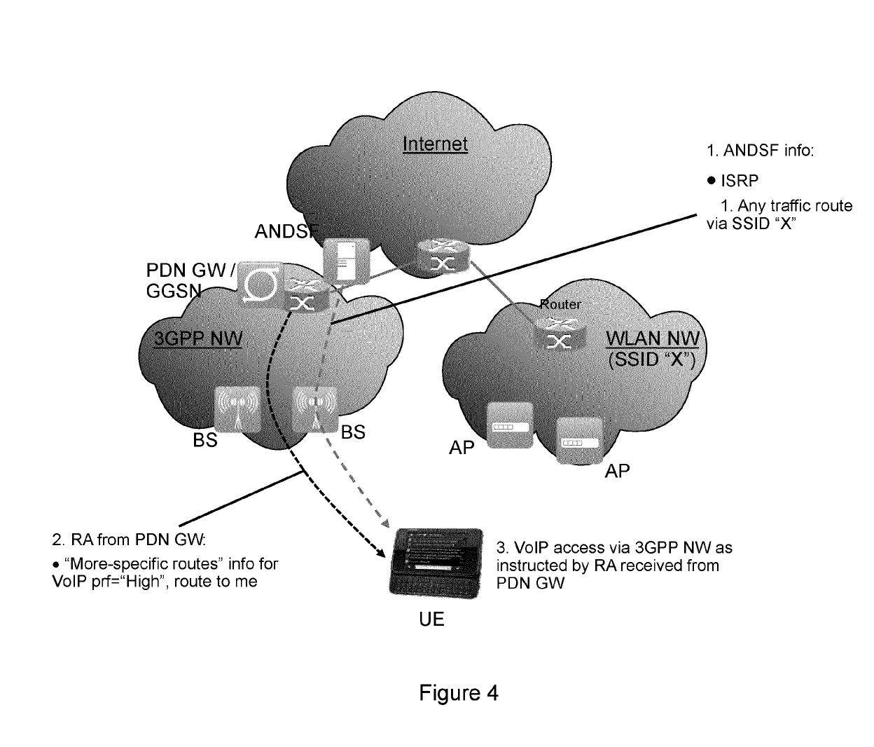

FIG. 4 shows a schematic diagram of a first exemplary use case according to exemplary embodiments of the present invention in the exemplary system architecture of FIG. 1. The thus illustrated use case relates to a combination of ANDSF ISRP and RA-based IETF mechanism/s in terms of traffic control.

In a first step, the UE receives ANDSF information from the ANDSF server of the 3GPP network, containing an Inter-System Routing Policy (ISRP). The ISRP contains a rule which defines that all traffic (node ANDSF/ISRP/ForFlowBased/<X>/IPFlow/<X> or node ANDSF/ISRP/ForNonSeamlessOffload/<X>/IPFlow/<X> is left empty denoting all traffic) is routed as indicated in ANDSF/ISRP/ForFlowBased/<X>/RoutingRule (or ANDSF/ISRP/ForNonSeamlessOffload/<X>/RoutingRule). The RoutingRule node contains one interior node with defines values AccessTechnology=WLAN, AccessId=X, Priority=1. This information may be stored by the UE for further use. In the preset example, the ISRP rule is interpreted by the UE to define that all traffic is routed via the WLAN network with SSID “X”.

In a second step (which may be prior to, (quasi) simultaneous with or after the first step), the UE receives a Router Advertisement (RA) from the PDN GW of the 3GPP network. In that RA, Route Information Option may for example contain e.g. a prefix for the (3GPP network) operator's VoIP service, and the preference value may for example be set to High. This information may be stored by the UE for further use. The UE interprets this RA information so that, whenever it has a packet matching the prefix value of the RA (i.e. a VoIP packet with the destination address matching the prefix value), the UE shall forward this packet to the router from which the RA was received, i.e. the PDN GW.

In view of the above information obtained in the first and second steps, the UE now has conflicting information from the ANDSF and RA received from PDN GW for VoIP traffic. Namely, the ANDSF has instructs the UE to use WLAN with SSID=“X” for any traffic (including also VoIP traffic), and the RA has instructed the UE to forward all VoIP packets to the PDN GW via 3GPP access.

According to the exemplary embodiments of the present invention, in a third step, the UE may use both kinds of information in a combined manner for traffic control. Specifically, the UE may use the ANDSF information to select the WLAN network with SSID “X” whenever it is available, but only for traffic other than VoIP traffic. However, for VoIP traffic, the RA information takes precedence over the ANDSF information. Accordingly, whenever the UE needs to make a routing/forwarding decision for a VoIP packet, it will follow the instructions included in the received RA. In the present example, the UE will forward all VoIP packets to the PDN GW via 3GPP access.

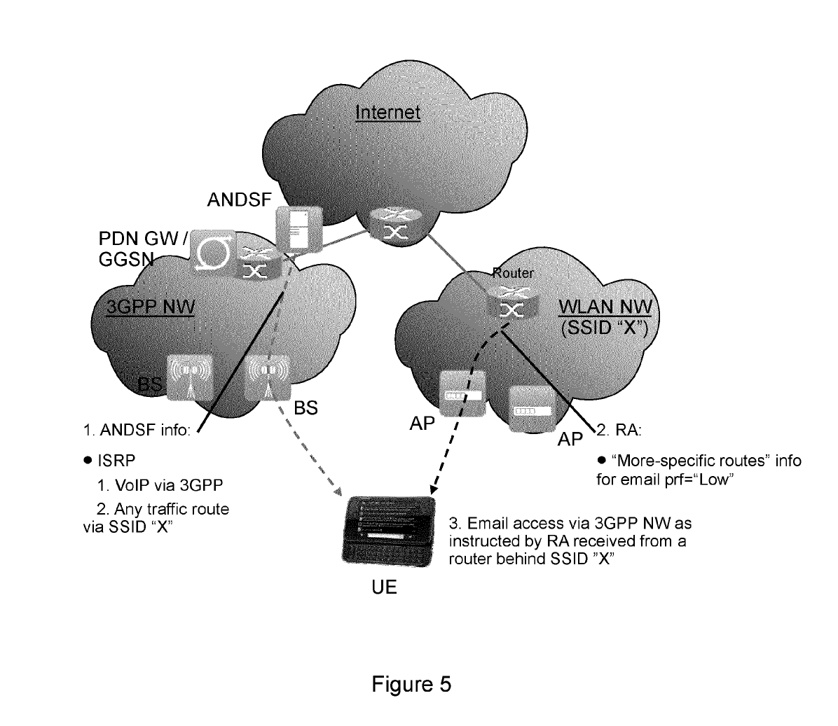

FIG. 5 shows a schematic diagram of a first exemplary use case according to exemplary embodiments of the present invention in the exemplary system architecture of FIG. 1. The thus illustrated use case also relates to a combination of ANDSF ISRP and RA-based IETF mechanism/s in terms of traffic control.

In a first step, the UE receives ANDSF information from the ANDSF server of the 3GPP network, containing an Inter-System Routing Policy (ISRP). The ISRP contains two rules, wherein the higher priority rule is defined for VoIP traffic and the lower priority rule is defined for all other traffic. The higher priority rule for VoIP traffic (node ANDSF/ISRP/ForFlowBased/<X>/IPFlow/<X> or node ANDSF/ISRP/ForNonSeamlessOffload/<X>/IPFlow/<X> identifies VoIP traffic e.g. by destination IP address, or range [=prefix]) defines that VoIP traffic is routed as indicated in ANDSF/ISRP/ForFlowBased/<X>/RoutingRule (or ANDSF/ISRP/ForNonSeamlessOffload/<X>/RoutingRule) that contains one interior node with defined value AccessTechnology=3GPP. The content of the lower priority rule for all other traffic is the same as in the previous example in connection with FIG. 4. Both information may be stored by the UE for further use. In the preset example, the ISRP rule is interpreted by the UE to define that VoIP traffic is routed via the 3GPP network, and all other traffic is routed via the WLAN network with SSID “X”.

In a second step (which may be prior to, (quasi) simultaneous with or after the first step), the UE receives a Router Advertisement (RA) from a router behind/in the WLAN network with SSID “X”. In that RA, Route Information Option may for example contain e.g. a prefix for an email service, and the preference value may for example be set to Low. This information may be stored by the UE for further use. The UE interprets this RA information so that, whenever it has a packet matching the prefix of the RA (i.e. a packet with the destination address matching the prefix value for the email server), the UE treats the router from which the RA was received as the least favorable first hop router. In practice, if there is any first hop router known to the UE other than the router behind/in the WLAN network with SSID “X”, from which the RA has been received, UE will use the other router for email traffic.

In view of the above information obtained in the first and second steps, the UE now has conflicting information from the ANDSF and RA received from PDN GW for email traffic. Namely, the ANDSF has instructed the UE to use the WLAN network with SSID=“X” for any traffic other than VoIP traffic (including also email traffic), and the RA has instructed the UE not to forward email traffic to the router that sent the RA, i.e. the router behind/in the WLAN network with SSID “X”.

According to the exemplary embodiments of the present invention, in a third step, the UE may use both kinds of information in a combined manner for traffic control. Specifically, the UE may use the ANDSF information to select the WLAN network with SSID “X” whenever it is available, but only for traffic other than email. However, for email traffic, the RA information takes precedence over the ANDSF information. Accordingly, whenever UE needs to make a routing/forwarding decision for an email packet, it will follow the instructions included in the received RA. In the present example, the UE will forward all email packets to the PDN GW via 3GPP access, since the PDN GW is assumed to be a known first hop router for the UE, and the PDN GW is treated with higher preference as first hop router than the router behind/in the WLAN network with SSID “X” (due to its preference value set to Low).

As evident from the above description of exemplary use cases in connection with FIGS. 4 and 5, traffic control according to the exemplary embodiments of the present invention may comprise transmitting traffic of the specified traffic type in accordance with at least one of the selected network or network technology type and the decided route. Also, the information obtaining according to the exemplary embodiments of the present invention may also comprise receipt of the information from respective sources, i.e. receiving the access-related network selection information from an ANDSF server of a cellular communication system and/or receiving the routing-related network selection information from at least one of a router and a DHCP server of a cellular communication system or a non-cellular communication system.

The above-described procedures and functions may be implemented by respective functional elements, processors, or the like, as described below.

While in the foregoing exemplary embodiments of the present invention are described mainly with reference to methods, procedures and functions, corresponding exemplary embodiments of the present invention also cover respective apparatuses, network nodes and systems, including both software and/or hardware thereof.

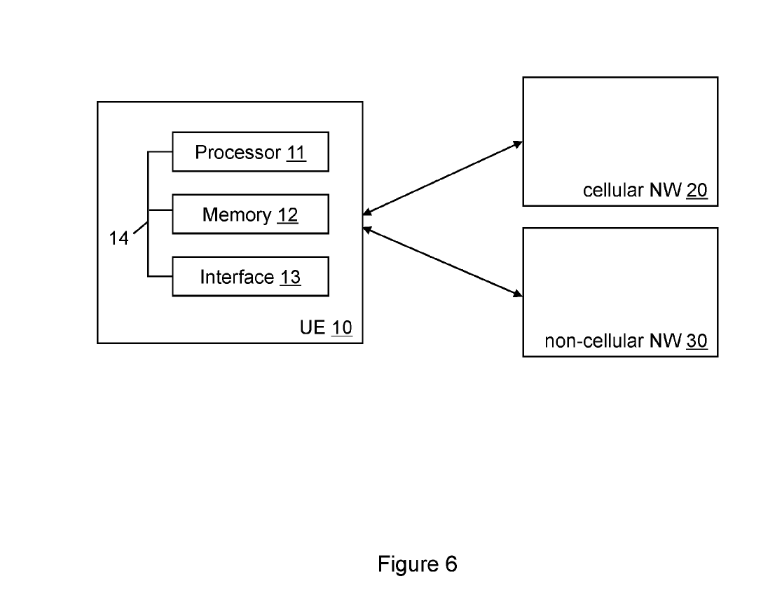

Respective exemplary embodiments of the present invention are described below referring to FIG. 6, while for the sake of brevity reference is made to the detailed description of respective corresponding schemes, methods and functionality, principles and operations according to FIGS. 1 to 5.

In FIG. 6 below, the solid line blocks are basically configured to perform respective operations as described above. The entirety of solid line blocks are basically configured to perform the methods and operations as described above, respectively. With respect to FIG. 6, it is to be noted that the individual blocks are meant to illustrate respective functional blocks implementing a respective function, process or procedure, respectively. Such functional blocks are implementation-independent, i.e. may be implemented by means of any kind of hardware or software, respectively. The arrows and lines interconnecting individual blocks are meant to illustrate an operational coupling there-between, which may be a physical and/or logical coupling, which on the one hand is implementation-independent (e.g. wired or wireless) and on the other hand may also comprise an arbitrary number of intermediary functional entities not shown. The direction of arrow is meant to illustrate the direction in which certain operations are performed and/or the direction in which certain data is transferred.

Further, in FIG. 6, only those functional blocks are illustrated, which relate to any one of the above-described methods, procedures and functions. A skilled person will acknowledge the presence of any other conventional functional blocks required for an operation of respective structural arrangements, such as e.g. a power supply, a central processing unit, respective memories or the like. Among others, memories are provided for storing programs or program instructions for controlling the individual functional entities to operate as described herein.

FIG. 6 shows a schematic diagram of an exemplary apparatus in a system scenario according to exemplary embodiments of the present invention.

In view of the above, the thus illustrated apparatuses 10, 20 and 30 are suitable for use in practicing the exemplary embodiments of the present invention, as described herein.

The thus illustrated apparatus 10 may represent a (part of a) terminal or user equipment or the like, or a modem (which may be installed as part of the terminal or user equipment or the like, but may be also a separate module, which can be attached to various devices, as described above), and may be configured to be involved in a system architecture as evident from FIGS. 1, 4 and 5, and to perform a procedure and/or exhibit a functionality as evident from FIGS. 2 to 5. As indicated in FIG. 6, the apparatus 10 may be connected/connectable to a cellular (type) network or a network element thereof, as denoted by 20, and a non-cellular (type) network or a network element thereof, as denoted by 30. The apparatus/network 20 may represent an ANDSF server, and the apparatus/network 30 may represent a router and/or a DHCP server (both of which may be implemented e.g. at/in/by a PDN GW and/or a GGSN in a cellular network).

As indicated in FIG. 6, according to exemplary embodiments of the present invention, the apparatus comprises a processor 11, a memory 12 and an interface 13, which are connected by a bus 14 or the like.

The processor 11 and/or the interface 13 may also include a modem or the like to facilitate communication over a (hardwire or wireless) link, respectively. The interface 13 may include a suitable transceiver coupled to one or more antennas or communication means for (hardwire or wireless) communications with the linked or connected device(s), respectively. The interface 13 is generally configured to communicate with at least one other apparatus, i.e. the interface thereof.

The memory 12 may store respective programs assumed to include program instructions or computer program code that, when executed by the respective processor, enables the respective electronic device or apparatus to operate in accordance with the exemplary embodiments of the present invention. For example, the memory 12 may store any network selection information received from any one of apparatuses/networks 20 and 30.

In general terms, the respective devices/apparatuses (and/or parts thereof) may represent means for performing respective operations and/or exhibiting respective functionalities, and/or the respective devices (and/or parts thereof) may have functions for performing respective operations and/or exhibiting respective functionalities.

When in the subsequent description it is stated that the processor (or some other means) is configured to perform some function, this is to be construed to be equivalent to a description stating that a (i.e. at least one) processor or corresponding circuitry, potentially in cooperation with computer program code stored in the memory of the respective apparatus, is configured to cause the apparatus to perform at least the thus mentioned function. Also, such function is to be construed to be equivalently implementable by specifically configured circuitry or means for performing the respective function (i.e. the expression “processor configured to [cause the apparatus to] perform xxx-ing” is construed to be equivalent to an expression such as “means for xxx-ing”).

In its most basic form, according to exemplary embodiments of the present invention, the apparatus 10 or its processor 11 is configured to perform obtaining (e.g. cellular type) access-related network selection information with respect to a network or a network technology type, obtaining (e.g. non-/cellular type) routing-related network selection information with respect to traffic type based routing information, and performing traffic control based on a combination of the access-related network selection information and the routing-related network selection information.

Accordingly, the apparatus 10 may comprise respective means for obtaining and means for performing traffic control.

As outlined above, in enhanced forms, the apparatus 10 may comprise one or more of respective means for selecting a network or a network technology type, means for deciding a route for routing of traffic of a specified traffic type, means for transmitting traffic of the specified traffic type, and means for receiving the (e.g. cellular type) access-related network selection information and/or the (e.g. non-/cellular type) routing-related network selection information.

For further details regarding the operability/functionality of the individual apparatuses, reference is made to the above description in connection with any one of FIGS. 1 to 5, respectively.

According to exemplarily embodiments of the present invention, the processor 11/21, the memory 12/22 and the interface 13/23 may be implemented as individual modules, chips, chipsets, circuitries or the like, or one or more of them can be implemented as a common module, chip, chipset, circuitry or the like, respectively.

According to exemplarily embodiments of the present invention, a system may comprise any conceivable combination of the thus depicted devices/apparatuses and other network elements, which are configured to cooperate as described above.

In general, it is to be noted that respective functional blocks or elements according to above-described aspects can be implemented by any known means, either in hardware and/or software, respectively, if it is only adapted to perform the described functions of the respective parts. The mentioned method steps can be realized in individual functional blocks or by individual devices, or one or more of the method steps can be realized in a single functional block or by a single device.

Generally, any method step is suitable to be implemented as software or by hardware without changing the idea of the present invention. Such software may be software code independent and can be specified using any known or future developed programming language, such as e.g. Java, C++, C, and Assembler, as long as the functionality defined by the method steps is preserved. Such hardware may be hardware type independent and can be implemented using any known or future developed hardware technology or any hybrids of these, such as MOS (Metal Oxide Semiconductor), CMOS (Complementary MOS), BiMOS (Bipolar MOS), BiCMOS (Bipolar CMOS), ECL (Emitter Coupled Logic), TTL (Transistor-Transistor Logic), etc., using for example ASIC (Application Specific IC (Integrated Circuit)) components, FPGA (Field-programmable Gate Arrays) components, CPLD (Complex Programmable Logic Device) components or DSP (Digital Signal Processor) components. A device/apparatus may be represented by a semiconductor chip, a chipset, or a (hardware) module comprising such chip or chipset; this, however, does not exclude the possibility that a functionality of a device/apparatus or module, instead of being hardware implemented, be implemented as software in a (software) module such as a computer program or a computer program product comprising executable software code portions for execution/being run on a processor. A device may be regarded as a device/apparatus or as an assembly of more than one device/apparatus, whether functionally in cooperation with each other or functionally independently of each other but in a same device housing, for example.

Apparatuses and/or means or parts thereof can be implemented as individual devices, but this does not exclude that they may be implemented in a distributed fashion throughout the system, as long as the functionality of the device is preserved. Such and similar principles are to be considered as known to a skilled person.

Software in the sense of the present description comprises software code as such comprising code means or portions or a computer program or a computer program product for performing the respective functions, as well as software (or a computer program or a computer program product) embodied on a tangible medium such as a computer-readable (storage) medium having stored thereon a respective data structure or code means/portions or embodied in a signal or in a chip, potentially during processing thereof.

The present invention also covers any conceivable combination of method steps and operations described above, and any conceivable combination of nodes, apparatuses, modules or elements described above, as long as the above-described concepts of methodology and structural arrangement are applicable.

In view of the above, there are provided measures for non-conflicting traffic control with different types of network selection information. Such measures exemplarily comprise performing traffic control based on a combination of (e.g. cellular type) access-related network selection information with respect to a network or a network technology type with (e.g. non-/cellular type) routing-related network selection information with respect to traffic type based routing information. Such measures are exemplarily, but not exclusively, applicable in the context of coexisting cellular and non-cellular networks or network technology types providing connectivity to a transport network.

The measures according to exemplary embodiments of the present invention may be applied for any kind of network environment, such as for example for communication systems in accordance with any related standards of 3GPP and/or 3GPP2 and/or IETF and/or IEEE, and so on, e.g. LTE standards (including LTE-Advanced and its evolutions) and/or UMTS standards, and/or WCDMA standards and/or HSPA standards.

Even though the invention is described above with reference to the examples according to the accompanying drawings, it is to be understood that the invention is not restricted thereto. Rather, it is apparent to those skilled in the art that the present invention can be modified in many ways without departing from the scope of the inventive idea as disclosed herein.

### LIST OF ACRONYMS AND ABBREVIATIONS

3G Third Generation
3GPP Third Generation Partnership Project
ANDSF Access Network Discovery and Selection Function
AP Access Point
BS Base Station
DHCP Dynamic Host Configuration Protocol
DSMIP Dual Stack Mobile IP
EPC Enhanced Packet Core
GGSN Gateway GPRS Support Node
GPRS General Packet Radio Service
GTP GPRS Tunneling Protocol
IEEE Institute of Electrical and Electronics Engineers
IETF Internet Engineering Task Force
IFOM IP Flow Mobility
IP Internet Protocol
ISMP Inter-System Mobility Policy
ISRP Inter-System Routing Policy
I-WLAN Interworking WLAN
LTE Long Term Evolution
MAPCON Multi Access PDN Connectivity
MIP Mobile IP
NW Network
PDN Packet Data Network
PDN GW PDN Gateway
PMIP Proxy Mobile IP
RA Router Advertisement
SSID Service Set Identifier
UE User Equipment
UMTS Universal Mobile Telecommunications System
VoIP Voice over IP
VPN Virtual Private Network
WCDMA Wideband Code Division Multiple Access
WiMAX Worldwide Interoperability for Microwave Access
WLAN Wireless Local Area Network

1. A method comprising
obtaining access-related network selection information with respect to a network or a network technology type,
obtaining routing-related network selection information with respect to traffic type based routing information, and
performing traffic control based on a combination of the access-related network selection information and the routing-related network selection information.

2. The method according to claim 1, wherein
the access-related network selection information is based on at least one of an inter-system mobility policy and an inter-system routing policy of an access network discovery and selection function, and
the routing-related network selection information is based on at least one of a router advertisement and a dynamic host configuration.

3. The method according to claim 2, wherein the traffic control is performed based on a combination of at least one of one or more inter-system mobility policy rules and one or more inter-system routing policy rules of the access-related network selection information and at least one of route information and preference information of the routing-related network selection information.

4. The method according to claim 2, wherein, when the access-related network selection information is based on the inter-system mobility policy, the traffic control comprises
selecting a network or a network technology type on the basis of one or more inter-system mobility policy rules of the access-related network selection information, and
deciding a route for routing of traffic of a specified traffic type on the basis of at least one of route information and preference information of the routing-related network selection information.

5. The method according to claim 2, wherein, when the access-related network selection information is based on the inter-system routing policy, the traffic control comprises
selecting a network or a network technology type on the basis of one or more inter-system routing policy rules of the access-related network selection information, and
deciding a route for routing of traffic of a specified traffic type on the basis of the one or more inter-system routing policy rules of the access-related network selection information and at least one of route information and preference information of the routing-related network selection information.

6. The method according to claim 5, wherein, when there is a conflict between a route decision for routing of traffic of a specified traffic type on the basis of the one or more inter-system routing policy rules of the access-related network selection information and a route decision for routing of traffic of the specified traffic type on the basis of the at least one of route information and preference information of the routing-related network selection information, the route for routing of traffic of the specified traffic type is decided by admitting precedence to the routing-related network selection information.

7. The method according to claim 4, wherein the traffic control comprises
transmitting traffic of the specified traffic type in accordance with at least one of the selected network or network technology type and the decided route.

8. The method according to claim 1, wherein the obtaining comprises at least one of
receiving the access-related network selection information from an access network discovery and selection function server of a cellular communication system, and
receiving the routing-related network selection information from at least one of a router and a dynamic host configuration protocol server of a cellular communication system or a non-cellular communication system.

9. The method according to claim 1, wherein
the method is operable at or by a terminal or user equipment or modem being connected with at least one network or network technology type, and/or
the network or the network technology type comprises at least one of a cellular network and a WiFi network.

10. An apparatus comprising
an interface configured to communicate with at least another apparatus,
a memory configured to store computer program code, and
a processor configured to cause the apparatus to perform:
obtaining access-related network selection information with respect to a network or a network technology type,
obtaining routing-related network selection information with respect to traffic type based routing information, and
performing traffic control based on a combination of the access-related network selection information and the routing-related network selection information.

11. The apparatus according to claim 10, wherein
the access-related network selection information is based on at least one of an inter-system mobility policy and an inter-system routing policy of an access network discovery and selection function, and
the routing-related network selection information is based on at least one of a router advertisement and a dynamic host configuration.

12. The apparatus according to claim 11, wherein the processor is configured to cause the apparatus to perform the traffic control based on a combination of at least one of one or more inter-system mobility policy rules and one or more inter-system routing policy rules of the access-related network selection information and at least one of route information and preference information of the routing-related network selection information.

13. The apparatus according to claim 11, wherein, when the access-related network selection information is based on the inter-system mobility policy, the processor is configured to cause the apparatus to perform in the traffic control
selecting a network or a network technology type on the basis of one or more inter-system mobility policy rules of the access-related network selection information, and
deciding a route for routing of traffic of a specified traffic type on the basis of at least one of route information and preference information of the routing-related network selection information.

14. The apparatus according to claim 11, wherein, when the access-related network selection information is based on the inter-system routing policy, the processor is configured to cause the apparatus to perform in the traffic control
selecting a network or a network technology type on the basis of one or more inter-system routing policy rules of the access-related network selection information, and
deciding a route for routing of traffic of a specified traffic type on the basis of the one or more inter-system routing policy rules of the access-related network selection information and at least one of route information and preference information of the routing-related network selection information.

15. The apparatus according to claim 14, wherein, when there is a conflict between a route decision for routing of traffic of a specified traffic type on the basis of the one or more inter-system routing policy rules of the access-related network selection information and a route decision for routing of traffic of the specified traffic type on the basis of the at least one of route information and preference information of the routing-related network selection information, the processor is configured to cause the apparatus to decide the route for routing of traffic of the specified traffic type by admitting precedence to the routing-related network selection information.

16. The apparatus according to claim 13, wherein the processor is configured to cause the apparatus to perform in the traffic control
transmitting traffic of the specified traffic type in accordance with at least one of the selected network or network technology type and the decided route.

17. The apparatus according to claim 10, wherein the processor is configured to cause the apparatus to perform at least one of
receiving the access-related network selection information from an access network discovery and selection function server of a cellular communication system, and
receiving the routing-related network selection information from at least one of a router and a dynamic host configuration protocol server of a cellular communication system or a non-cellular communication system.

18. The apparatus according to claim 10, wherein
the apparatus is operable as or at a terminal or user equipment or modem being connected with at least one network or network technology type, and/or
the network or the network technology type comprises at least one of a cellular network and a WiFi network.

19. A computer program product comprising computer-executable computer program code which, when the program is run on a computer, is configured to cause the computer to carry out the method according to claim 1.

20. The computer program product according to claim 19, wherein the computer program product comprises a computer-readable medium on which the computer-executable computer program code is stored, and/or wherein the program is directly loadable into an internal memory of the processor.
